(19) United States
(12) Patent Application Publication
(10) Pub. No.: US 2006/0036747 A1
(43) Pub. Date: Feb. 16, 2006

(54) System and method for resource handling of SIP messaging

(76) Inventors: James P. Galvin JR., Oak Ridge, NC (US); James W. Lawwill JR., Winchester, KY (US); Brian G. Cline, Hebron, KY (US); Uri Segev, Or-Yehuda (IL); Avshalom Houri, Netivot (IL); Amir Perlman, Yahud (IL); Ofira Tal-Aviv, Rehovot (IL); Brian Pulito, Lexington, KY (US)

Correspondence Address: BROWN, RAYSMAN, MILLSTEIN, FELDER & STEINER LLP, 900 THIRD AVENUE, NEW YORK, NY, 10022, US

(21) Appl. No.: 11/191,334

(22) Filed: Jul. 28, 2005

Related U.S. Application Data
(60) Provisional application No. 60/591,729, filed on Jul. 28, 2004.

(51) Int. Cl. G06F 15/16

(52) U.S. Cl. 709/228

(57) ABSTRACT

A system and method is provided that includes a communication system for handling Session Initiation Protocol (SIP) messages. The system includes a plurality of first servers for processing a first and a second message. The system also includes a plurality of second servers, which may include a mapping/correlating function for receiving the first message from a client and sending the first message to the plurality of first servers based on associating the first message with a resource. The second message received from the plurality of first servers is sent to the client based on stored routing information associated with the client, whereby the stored routing information resides within the plurality of second servers.

### CROSS-REFERENCE TO RELATED APPLICATIONS

The present application claims the benefit under 35 U.S.C. § 119(e) from U.S. Provisional Patent Application Ser. No. 60/591,729, filed Jul. 28, 2004, the contents of which is incorporated by reference in its entirety.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention relates generally to a system and method for handling Session Initiation Protocol (SIP) and SIP Instant Messaging and Presence Leveraging (SIMPLE) messaging. More particularly, the present invention relates to managing and configuring a system's resources to handle messages based on the application of SIP and SIMPLE protocols in a communications environment.

The SIP protocol may be used establish, to modify, and terminate multimedia, or other communication sessions such as videoconferencing, voice over IP, and multi-way instant messaging. The management of such a communication infrastructure may include the provisioning of certain techniques and configurations, which may include, clustering, proxying, and session affinity.

### SUMMARY OF THE INVENTION

According to an embodiment of the present invention, a communication system for handling Session Initiation Protocol (SIP) messages is provided. The system may include application servers for processing a first and second messages. The system may also include one or more proxy servers, which may utilize mapping functions to receive a first message from a client and route the first message to certain application servers by associating the first message with a resource. A second message received from an application server may be sent to the client based on stored routing information associated with the client within the proxy servers.

According to an embodiment of the present invention, the mapping function may include an affinity mapping table for mapping the first message to a designated one of the plurality of second servers based on a To: header field within the first message.

According to another embodiment of the present invention, the plurality of second servers may include a routing table that stores the routing information, wherein the routing table maps and/or correlates the second message from a designated one of the plurality of first servers to a designated one of the plurality of second servers based on a Contact header field within the second message.

According to an embodiment of the present invention, a method of handling Session Initiation Protocol (SIP) messages is provided. The method may include accessing first header information associated with a SIP message, and identifying an application server and forwarding the SIP message to the application server based on correlating information associated with the first header information. Second header information associated with the SIP message may be accessed, whereby routing information associated with a client may be provided based on correlating the second header with the routing information associated with the client.

According to yet another embodiment of the present invention, a method of managing failover in a communication system including application servers in communication with proxy servers is provided. The method may include detecting a communication loss between one of the proxy servers and one of the application servers, and updating a proxy server entry from data used for mapping Session Initiation Protocol (SIP) messages to the application servers. The method may also further include sending information associated with the updated entry to some or all of the other proxy servers.

### BRIEF DISCRIPTION OF DRAWINGS

The invention is illustrated in the figures of the accompanying drawings, which are meant to be exemplary and not limiting, and in which like references are intended to refer to like or corresponding parts, and in which:

FIG. 1 is a block diagram of a system incorporating a SIP protocol according to an embodiment of the present invention;

FIG. 2 is a flowchart illustrating the handling of inbound messages by the system shown in FIG. 1 according to an embodiment of the present invention; and

FIG. 3 is a flowchart illustrating some of the steps associated with the handling of outbound messages by the system shown in FIG. 1 according to an embodiment of the present invention.

### DETAILED DESCRIPTION

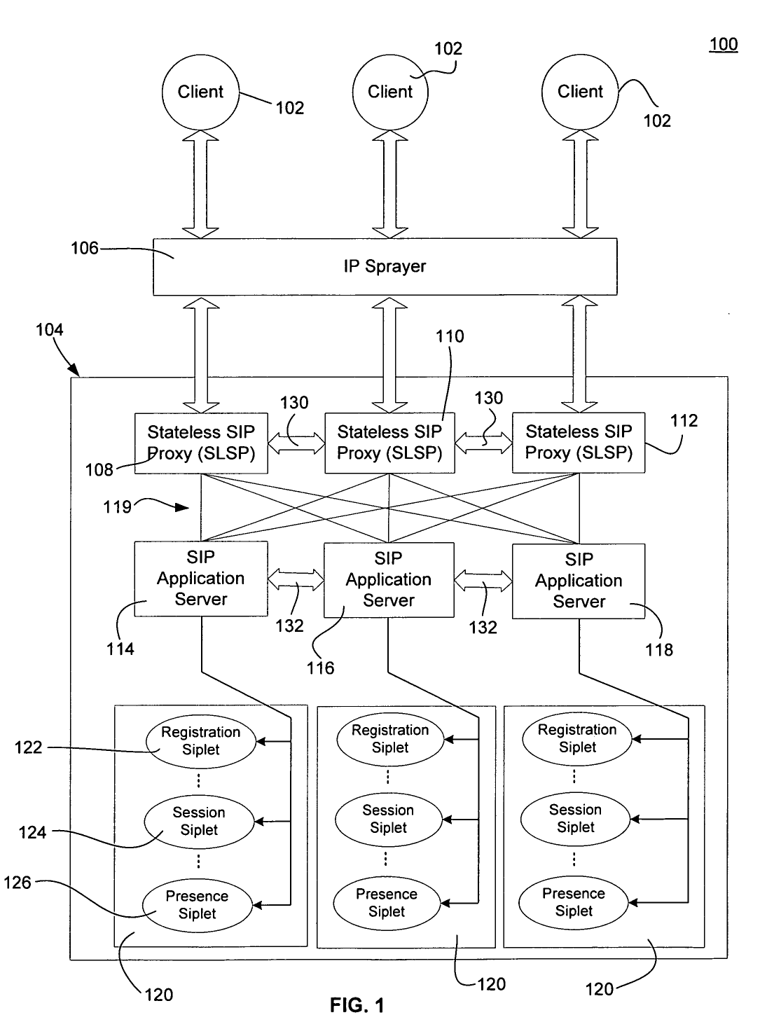

FIG. 1 illustrates a system 100 that includes a SIP protocol according to an embodiment of the present invention. System 100 may include a plurality of client devices 102 (e.g., one or more computers or servers, etc.) that communicate with one or more Session Initiation Protocol (SIP) containers 104 via an IP sprayer 106 (e.g., Network Dispatcher). IP sprayer 106, among other things, may distribute data received from client 102 and various components in SIP container 104. In some embodiments, IP sprayer 106 may be configured as a server and may distribute data substantially evenly among SLSPs.

SIP container 104 may include one or more Stateless SIP Proxies (SLSP) 108, 110, 112 and may couple to certain Session Initiation Protocol (SIP) application servers 114, 116, 118 via connection network 119. SLSPs 108, 110, 112 may be considered a cluster of SLSPs. A cluster may be considered, in some configurations, as a group of computers that may be interconnected and communicate among each other for the purpose of sharing and distributing processing capabilities. For example, SLSP devices 108, 110, and 112 may be coupled to some or all SIP application servers 114, 116, and 118 (directly or indirectly). Application servers 114, 116, 118 may operate a series of siplets 120, which may provide the necessary software for handling various SIP messages within the system 100. A siplet may be considered as SIP servlets, which may be a software program or other routine running on a server. Therefore, the siplets may be considered a software program or application residing on the servers 1114, 116, 118 that handle SIP messages.

Examples of siplets that may handle SIP messages at an application server may include REGISTRATION, SESSION, and PRESENCE commands. However, other siplets may be used if desired. In operation, the REGISTRATION siplet 122 may operate in a conventional manner, which may include handling a REGISTER request when a SIP client or user connects to a server. Based on the REGISTER request, the REGISTRATION siplet 122 may register the user's presence by, among other things, enabling the SIP server to recognize the client or user connecting to the server which may include certain characteristics of the device used for this connection (e.g., PC, cell phone, PDA, etc.).

As previously mentioned, other examples of message handling siplets may include the SESSION siplet 124 and PRESENCE siplet 126. The SESSION siplet 124 may handle some or all of the particulars for establishing media sessions (e.g., facilitating the creation of web conferences) and in some embodiments may use the same routing database or information source maintained by the REGISTRATION siplet 122. PRESENCE siplet 126, for example, in a SIP environment, may publish a user or client's PRESENCE information. Examples of such PRESENCE information may include “the client is in a meeting” or “ready to accept traffic” etc. PRESENCE siplet 126 may also include the handling of a buddy list application.

Request and response messaging data that is transmitted from clients 102 to IP sprayer 106 may be distributed among SLSP proxies 108, 110, and 112. Although IP sprayer 106 may be programmed to operate in various modes, in one embodiment of the present invention, different request messages sent by the clients to sprayer 106 may be distributed by sprayer 106 across the SLSP proxys in a cluster. Such distribution may be performed based on capacity or load balancing considerations. In some embodiments, this may provide a substantially more even distribution of the data load to or across the proxys. In one distribution mode, for example, messages may be delivered to the proxys in a substantially multiplexed manner, where a first request message may be sent by IP sprayer 106 to proxy 108, a second request may be sent by the IP sprayer 106 to proxy 110, and a third request may be sent by sprayer 106 to proxy 112, etc.

Messages associated with a client or group of clients (e.g., multi-way conferencing) that are received by a SLSP proxy (e.g., proxy 108) may be sent to one of the SIP application servers based on the target resource that they are accessing. For example, if a client is requesting to subscribe to another user's presence, the user may be designated as a target resource to be handled by an assigned application server. In this case, SLSP proxys 108, 110, 112 may include an affinity routing table that may be maintained for, among other things, mapping a request for access to a particular resource (e.g., a client or multiple client groups) to a particular application server. This mapping may be accomplished based on the To: field within the SIP header message. This field may include the recipient of the request (i.e., logical name of user). When a request is sent to subscribe, for example, to another user's presence, the routing table may be consulted for the necessary information to route messages to the user based on the particular application server that handles the user's presence.

As illustrated in FIG. 1, SLSP proxys 108, 110, 112 may communicate via communication links 130. These communication links may include waveguide (e.g., coax, fiber optic cable, ribbon cable etc.) and/or wireless communication capabilities (e.g., infra-red, rf radio, microwave radio, etc.) for providing communication between proxys. Moreover, links 130 may include different communication signaling methods and protocols. Each of the SLSP proxys may replicate affinity routing information within their respective routing tables in real-time and send this routing information to the other SLSP proxies within the cluster over links 130. One benefit of this arrangement is it provides a backup-mechanism in the event of failover conditions, where one or more proxy servers may be out of service or off-line.

Application servers 114, 116, and 118 may periodically replicate state information associated with the resources that they each handle and share this state information among each other via communication link 132. For example, if a first client request is identified as a first resource that is assigned to application server 114, a second client request is identified as a second resource that is assigned to application server 116, etc., each resource's state information (e.g., presence information) may be exchanged among some or all of the application servers via communication links 132. Communication links 132 may include waveguide (e.g., coax, fiber optic cable, ribbon cable etc.) and/or wireless communication capabilities (e.g., infra-red, rf radio, microwave radio, etc.) for providing communication between proxys. Moreover, links 130 may include different communication signaling methods and protocols. State and other information associated with resources accessed by a client or user may be exchange for, among things, failover conditions. Failover conditions may occur when a SIP proxy or application server fails to process inbound and outbound SIP messages or goes off-line due to a communication failure (e.g., damaged network interface). Also, server components 108, 110, 112, 114, 116, 118 illustrated in FIG. 1 may be any type of remote computer, network, database, or repository capable of receiving and processing data or information.

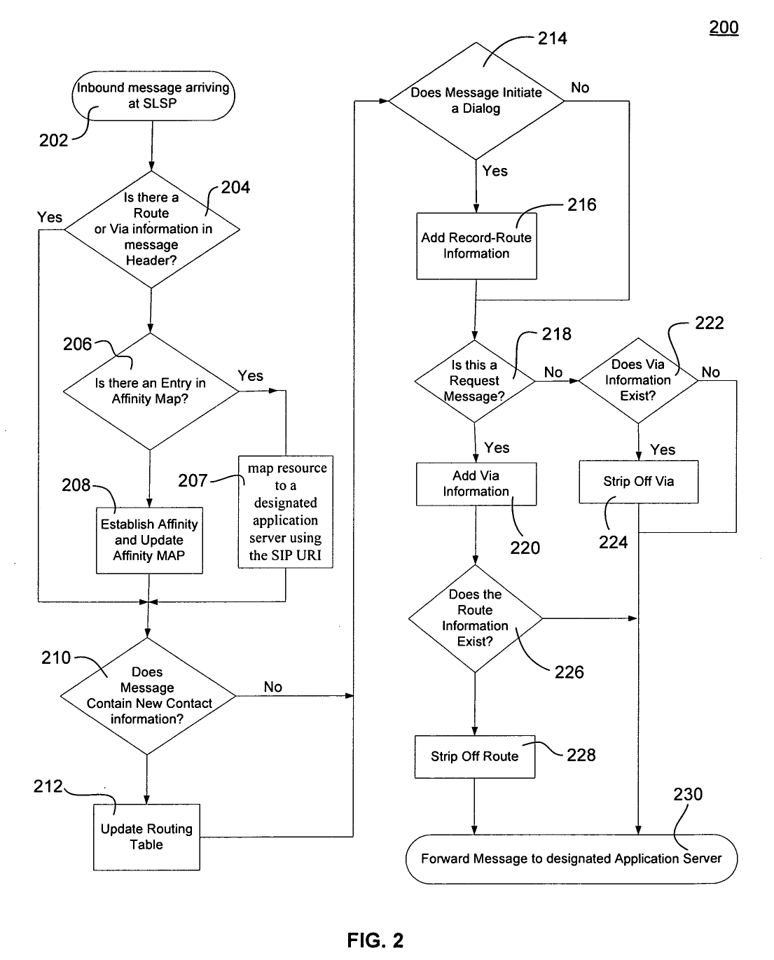

FIG. 2 is a flowchart 200 illustrating some of the steps associated with routing and processing inbound messages in accordance with an embodiment of the present invention. At step 202, a message may be received at one of the SLSP proxies 108, 110, 112 (FIG. 1). Next, at step 204, it may be determined whether the header associated with the received SIP message includes Route or Via information. Headers in SIP messages may generally provide information about the request or response message. For example, Via headers may store proxy information that handle the routing of the request, thus, providing path information. A Route header may, for example, recognize a need to retain one or more proxys in the signaling path to maintain data security. For example, if a SIP response message is received at a SIP proxy, the Via header within this message may be used for routing purposes. This routing may be achieved as a result of the Via header containing the path taken by the request. If, however on the other hand, the received message is a SIP request, the Route information in the header may provide a means for routing the message.

If, at step 204, it is determined that Route or Via header information exists in the message, then a target application server may be identified based on these header fields and the process may proceed to step 210. If at step 210 it is established that the message contains new contact information, then at step 212 the routing table (within an SLSP) may be updated to include the new contact information and its associated routing information.

If there is no Route or Via information in the header (step 204), at step 206 the SIP Universal Resource Identifier (URI) in the To: field may be used to determine whether the target resource (e.g., client, group of user's, or user) already has affinity to one of the application servers in the cluster. If an entry already exists in the affinity map, the resource may be mapped to a designated application server using the SIP URI found in the To: field of the SIP header at step 207.

Messages associated with each user identified as a resource may be handled by the same designated application server based on the affinity routing that is accomplished by SLSP cluster 108, 110, and 112. If at step 208 it determined that there is no entry in the affinity map corresponding to the target resource to which the message is directed, then affinity may be assigned based on a hashing algorithm, whereby a particular application server is assigned to that particular resource using a hashing function. For example, by computing the hash value associated with each resource (e.g., user), a numerical value may be associated with that resource, which may be used to correlate that user with a particular designated application server. After this assignment has been made, the affinity map associated with all SLSP proxies 108, 110, 112 may be updated. In some embodiments, such updates may be done in substantially real-time.

Following the establishment of affinity (step 208), the SLSP proxys may determine whether certain requests such as a REGISTER, SUBSCRIBE, or INVITE request is received. If so, the SLSP proxys may determine whether Contact header information exists (step 210). Based on the existence of a Contact header, a routing association between the Contact SIP URI and the client connection may be created at the SLSP proxy receiving the message (step 210). After the routing association between the Contact SIP URI and the client connection is created the routing table at the SLSP proxy may be updated based on this information (step 212).

At step 214, it may be determined whether the message initiates a dialog. If the message does initiate a dialog, then at step 216 Record-Route information may be added to the message header prior to going to step 218. If the message does not initiate a dialog, then at step 218 it may be determined whether the message is a request. If the message is a request, Via information is added to this message (step 220). If at step 226 it is determined that route information exists in the message header, at step 228 the route information may be stripped off or otherwise removed from the header prior to being forwarded to one of designated application servers at step 230.

Alternatively, if at step 218 it is determined that the message is not a request (e.g., a response), at step 222 it may be determined whether Via information exists in the message header. If no Via information may be in the header, at step 230 the message is forwarded to a designated application server. If at step 222, Via information is determined to exist in the header, this Via information may be stripped or otherwise removed at step 224 prior to being forwarded to one of designated application servers.

Referring to FIG. 1, as previously described, a hashing algorithm may be used to provide a hash of the SIP-URI in the To: field of the inbound SIP messages for providing affinity routing to one of the application servers. In order to accomplish this, some or all SLSP servers in the cluster may have access to the same data or information associated with the status (e.g., inactive, off-line, etc.) of the application servers to which they are coupled. Therefore, it may be desirable that information associated with any servers that may become inactive or shut down be synchronized or otherwise communicated across SLSP servers 108, 110, 112 in the cluster to provide redundant communication paths. Each SLSP 108, 110, 112 in the cluster may notify others that it is no longer in communication (i.e., connection loss) with one of the application servers 114, 116, 118 in order to facilitate load balancing and avoid failover conditions.

If, for example, an SLSP proxy (e.g., proxy 110) detects such a communications loss with an application server (e.g., server 114), the application server may be removed from the list or table used for affinity routing at that SLSP proxy. Following this change to the list or table, the SLSP proxy 110 may send the updated affinity information associated with the application server to other SLSP proxys in the cluster. The hash algorithm may also facilitate the minimization of race conditions, which may occur when two users are trying to access a certain resource at the same time before affinity to that resource has been established.

Use of the hash algorithm may facilitate, among other things, a more even distribution of data load across the application servers. For example, if two SLSP proxys receive requests to access the same resource (e.g., the same user's presence), it may be desirable for the request to be handled by the same application server that initially processed subsequent requests for accessing that resource. The use of the hash algorithm by the SLSPs may ensure that this request will be directed to the same application server.

In some embodiments, enhanced results associated with the hash algorithm performing the load balancing function may be obtained by the SLSPs using the same hash algorithm and having up-to-date information associated the number of application servers in the cluster. For example, if two SLSPs in a cluster have information associated with a different number of active application servers (e.g., one SLSP being unaware that another SLSP is inactive), the hashing may not generate data that is particularly useful. This may, for example, occur as a result of the hashing algorithm calculation based on use of an incorrect number of application servers that are actually operating within a cluster of application servers. This condition may, however, occur over a limited time window, such as when the SLSPs synchronize their data information associated of the status of application servers within the cluster. Once synchronized, the hashing may generate the data more useful for load balancing.

SLSP servers 108, 110, 112 may attempt to reconnect to a failed application server (e.g., server 118) several times before determining that the application server 118 is down. Following this determination, some or all SLSP server 108, 110, 112 may attempt to reconnect to the failed application server 118 periodically (e.g., approximately every 30 seconds). Also, once an SLSP proxy server (e.g., proxy 108) has detected that an application server is down (e.g., server 118), the SLSP proxy 108 may update the data information in its affinity map so entries that map inbound SIP messages to application server 118 may be mapped to other application servers (e.g., servers 114 or 116) in the SLSP server's 108 affinity table.

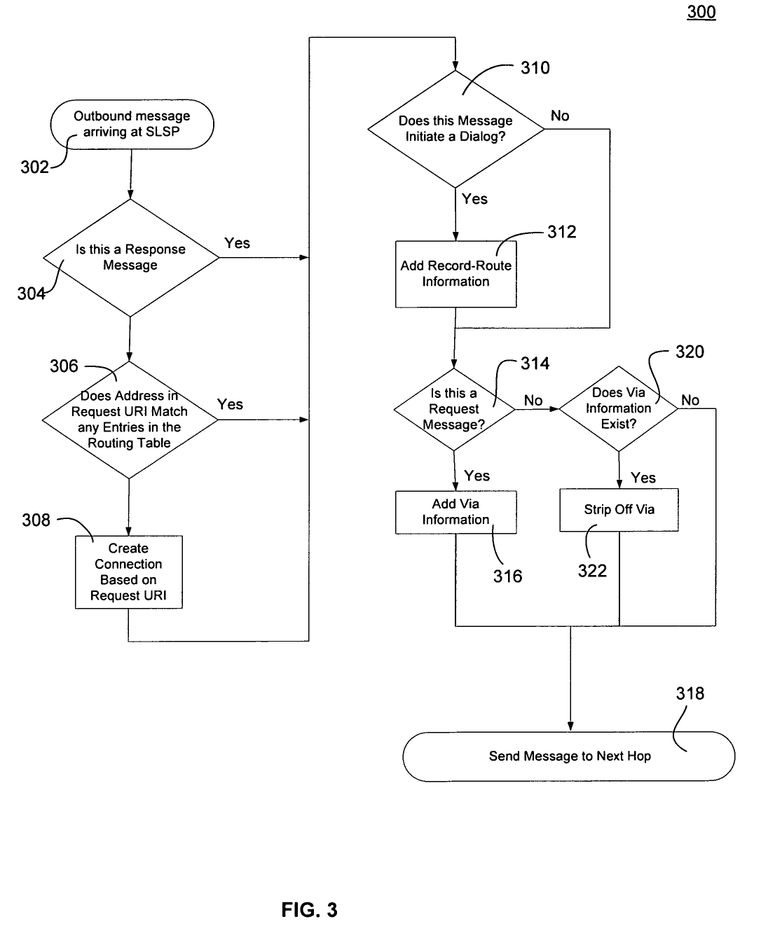

FIG. 3 is a flowchart 300 illustrating some of the steps associated with routing and processing outbound messages in accordance with an embodiment of the present invention. At step 302, an outbound message may be received at a designated SLSP proxy. This proxy may be designated based on identifying which proxy had previously handled the inbound message associated with this received outbound message (i.e., use the same resource previously used by outbound messages).

At step 304, it may be determined whether the message is an outbound response message or a request. If the message is not an outbound response message (i.e., an outbound request message), it may be determined whether the address in the request URI matches an entry in the routing table of the SLSP proxy receiving the request message (step 306). Based on the address in the request URI, a connection may be selected from the routing table (step 308). After it has been determined that the outbound message is a response message (step 304), the system may proceed to step 310, where it may be determined whether the message initiates a dialog. If the message does initiate a dialog, Record-Route information may be added to the message header (step 312). If the message does not initiate a dialog, it may be determined whether the message is a request message (step 314).

At step 314, if it is determined that the message is a request message, Via information may be added to the message header at step 316 prior to sending the message to the next point or hop along the route, as indicated at step 318. At step 314, if it determined that the message is not a request message, it may be determined whether Via information exist in the message header (step 320). If Via information is present in the message header, it may be removed from the header at step 322 prior to the message being forwarded to the next point, as indicated at step 318. If at step 320 it is determined that no Via information exists in the header, the message may be forwarded to the next point at step 320.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In some cases the order of process steps may be varied without changing the purpose, effect or import of the methods described.

What is claimed is:

1. A communication system for handling Session Initiation Protocol (SIP) messages, comprising:
a plurality of first servers for processing a first and second message; and
a plurality of second servers comprising a mapping function for receiving the first message from a client and sending the first message to the plurality of first servers based on associating the first message with a resource, and sending the second message received from the plurality of first servers to the client based on stored routing information associated with the client.

2. The system according to claim 1, wherein the mapping function comprises an affinity mapping table for mapping the first message to a designated one of the plurality of first servers based on a To header field within the first message.

3. The system according to claim 1, wherein the plurality of second servers further comprises a routing table including the stored routing information, wherein the routing table maps the second message from a designated one of the plurality of first servers to the client based on a Contact header field within the second message.

4. The system according to claim 1, wherein at least some of the plurality of first servers comprise an application server.

5. The system according to claim 1, wherein the one of a plurality of second servers comprises a stateless SIP proxy server.

6. A method of handling Session Initiation Protocol (SIP) messages, comprising:
accessing first header information associated with a SIP message;
identifying one of a plurality of servers and forwarding the SIP message to the identified one of a plurality of servers based on correlating information associated with the first header information;
accessing second header information associated with the SIP message; and
providing routing information associated with a client based on correlating the second header.

7. The method according to claim 6, wherein the one of a plurality of servers comprises an application server.

8. The method according to claim 6, wherein the first header information is correlated by an affinity table at a stateless SIP proxy.

9. The method according to claim 6, wherein the first header information comprises information associated with a resource to which the SIP message is directed.

10. The method according to claim 9, wherein the information associated with a resource comprises a Uniform Resource Identifier (URI).

11. The method according to claim 9, wherein the information associated with a resource comprises a To field.

12. The method according to claim 8, wherein the first header information associated with the SIP message is accessed at one of a plurality of proxy servers, wherein the affinity table exits at the one of a plurality of proxy servers.

13. The method according to claim 12, wherein the one of a plurality of proxy servers comprises a stateless SIP proxy.

14. The method according to claim 12, wherein information associated with the affinity map within each of the plurality of proxy servers is replicated between other ones of the plurality of proxy servers.

15. The method according to claim 14, wherein the information is replicated in real-time.

16. A method of managing failover in a communication system including a first plurality of servers in communication with a second plurality of servers, the method comprising:
detecting a communication loss between one server of the first plurality of servers and one server of the second plurality of servers;
updating from within the one server of the first plurality of servers an entry from a collection of data used for mapping Session Initiation Protocol (SIP) messages to the second plurality of servers; and
sending information associated with the updated entry from the collection of data within the one server of the first plurality of servers to all other of the first plurality of servers.

17. The method according to claim 16, further comprising forwarding the Session Initiation Protocol (SIP) messages to another one server of the second plurality of servers based on the sent information associated with the updated entry from the collection of data.

18. The method according to claim 17, wherein the Session Initiation Protocol (SIP) messages are forwarded to another one server of the second plurality of servers by applying an algorithm to a header field within the Session Initiation Protocol (SIP) messages.

19. The method according to claim 16, further comprising creating a new data entry at the all other of the first plurality of servers, wherein the created new entry is associated with the sent updated entry from the collection of data.

20. The method according to claim 16, wherein the collection of data comprises an affinity mapping table.

21. The method according to claim 16, wherein the first plurality of servers comprises a plurality of stateless SIP proxy servers.

22. The method according to claim 16, wherein the second plurality of servers comprises a plurality of application servers.

23. The method according to claim 16, further comprising making at least one reconnection attempt by the one server of the first plurality of servers to the one server of the second plurality of servers.

24. The method according to claim 16, wherein the algorithm is a distributed hash map.

25. The method according to claim 16, wherein the updating of the entry from the collection of data comprises removing the entry.

25. The method according to claim 16, wherein the updating of the entry from the collection of data comprises overwriting the entry.
